(19) United States
(12) Patent Application Publication
(10) Pub. No.: US 2008/0235626 A1
(43) Pub. Date: Sep. 25, 2008

(54) ELECTRONIC PAPER DEVICE FOR USE BY AIRCRAFT AND RAILWAY PASSENGERS

(75) Inventor: Rolf STEFANI, West River, MD (US)

Correspondence Address: PRASS & IRVING, LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 11/770,060

(22) Filed: Jun. 28, 2007

Related U.S. Application Data
(63) Continuation-in-part of application No. 11/755,350, filed on May 30, 2007.
(60) Provisional application No. 60/896,484, filed on Mar. 22, 2007.

(51) Int. Cl. G06F 3/048; G06F 3/033

(52) U.S. Cl. 715/840; 345/179; 705/400

(57) ABSTRACT

An electronic paper device is disclosed for use by aircraft passengers. The electronic paper device may include a communication interface that facilitates downloading of media publications, the media publications being available for download prior to each flight, a memory that stores the media publications, a user interface that facilitates access and use of the media publications by a user, and an electronic paper display that displays the media publications to the user in a manner that permits viewing in lighting conditions similar to that required of paper (including bright light).

### PRIORITY INFORMATION

This non-provisional application claims priority from U.S. provisional application Ser. No. 60/896,484, filed Mar. 22, 2007, and is a continuation-in-part of U.S. non-provisional application Ser. No. 11/755,350, filed May 30, 2007, the content of which is incorporated by reference in its entirety.

### BACKGROUND OF THE DISCLOSURE

1. Field of the Disclosure

The disclosure relates to applications for e-paper devices.

2. Introduction

The personal computer based devices in aircraft are a relatively new advance in aviation. The typical PC/notebook or tablet computer proposed today is not generally networked or connected to content management systems necessary to guarantee the validity and integrity of the data. Secondly, current shortcomings of conventional portable PC type of technology limit their actual usefulness and ability to be of great value.

### SUMMARY OF THE DISCLOSURE

An electronic paper device is disclosed for use by aircraft passengers. The electronic paper device may include a communication interface that facilitates downloading of media publications, the media publications being available for download prior to each flight, a memory that stores the media publications, a user interface that facilitates access and use of the media publications by a user, and an electronic paper display that displays the media publications to the user in a manner that permits viewing in lighting conditions similar to that required of paper (including bright light).

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary eReader network system diagram in accordance with a possible embodiment of the disclosure;

FIG. 2 illustrates an exemplary eReader in accordance with a possible embodiment of the disclosure;

FIG. 3 illustrates a block diagram of an exemplary eReader in accordance with a possible embodiment of the disclosure; and

FIG. 4 is an exemplary flowchart illustrating one possible eReader implementation process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure. Note that while this disclosure discusses aircraft, airline and railway travel uses for the disclosure, the disclosure is by no means limited to that area and may be applied to a wide variety of environment and uses.

This disclosure concerns targeted products and services developed to provide electronic paper based computing devices and highly automated systems which will reduce the need for and use of paper in specific travel market segments. Although, aviation and railway applications are discussed herein, the disclosure is not limited to those applications and may be applied to other industries and businesses.

The problems with conventional passenger media publication and entertainment systems are many and interwoven. For the on-board paper media publication utilization model:
Media publications are very heavy and require expenditure of fuel which airlines would rather dedicate to lifting revenue producing cargo or passengers,
Timeliness of new data is compromised due to the difficulty of distributing new paper media publications,
Airline cost in producing new paper versions. Cost in paper and manpower required to deliver the paper to aircraft,
Storage for massive paper volumes on the aircraft,
Inability to account for the distribution of media publications, and
Paper based media publications are very labor intensive and time consuming to produce.

Problems and shortcomings of existing electronic based document display systems are mostly technology based. They include:
Very expensive cost of electronics. Particularly due to their non portable nature, certain certification requirements make them extremely expensive to implement,
PC technology such as tablet electronic devices are;
   Very expensive,
   Require being connected to aircraft power—limited battery life,
   Do not work well (if at all) in sunlight saturated aircraft cockpits,
   Viewing angles are very limited by LCD technology,
   Are far too bright for use at night in a dark cockpit,
   Devices are large and heavy, produce heat,
User interface designs and implementations are too complex and require significant training,
Typically there is no seamless integration of devices to a content management system,
Are not removable from the aircraft,
Cannot be used by individuals away from the aircraft.

Current systems and methods are not easily implemented. The return on investment required to make economic sense for an airline or railway in order to implement systems that marginally fulfill their needs has stalled acceptance of PC based electronic platforms in most operations.

Thus, unique attributes of the eReader hardware disclosed herein, overcome all of the technical limitations of LCD based electronic display devices coupled with a complete system and services offering to serve as an attractive means to a customer desired end state of reducing or virtually, eliminating paper on aircraft.

The main notion is that eReader can perform (relating to paper) much better at a small fraction of the price and is not designed to perform multiple functionalities other than document viewing/management, calculations, and electronic updates/messages. This is due to the idea that the eReader is targeted at replacing paper with as close to paper functionality as possible (which can only be accomplished with e-paper based technology) and providing passengers with the appropriate functional user interface required.

This disclosure describes products and services developed to provide electronic paper based devices and highly automated systems which will reduce the need for and use of paper in the aviation/railway market segments. The products and services discussed herein are all based on the same core technology (device and automated content management system) but may have different user interface designs and content distribution architectures and capabilities that differentiate the product and systems from each other.

The e-paper based products and services discussed herein facilitate user interaction with digital versions of conventional paper publications. The software and system capabilities imbedded within the eReader suite of products and services that provide automated and interactive methods of ensuring information can be displayed on eReader devices, are easy to interact with and provide information that is valid and more current than any other comparable product available.

The eReader is a modular, integrated hardware and software system that provides a completely scaleable architecture enabling airlines and railways with the flexibility to choose solutions that fit their needs. By implementing eReader products and services, airlines and railways will be able to help reduce their costs and establish convenient access to digital documents while being digitally connected to their dispatch and host processing systems as required to acquire up-to-date media publications for the passenger's enjoyment.

The highly tailored and device specific user interface incorporated into the eReader software carefully exploits the attributes of the e-paper device in order to deliver simple and easy-to-use functionality. The eReader has many unique physical attributes, such as providing the first document reader that could actually be viewed in a sun-filled passenger cabin. While many other technologies have been developed with the same objective of providing a reading device for travelling passengers, all fell short on basic requirements, such as long power life, easy-to-use interface, viewing in sunlight, portability, and a practical size for use in a passenger cabin.

The eReader product was designed and released to provide the platform and custom user interface to allow passengers to access the above-mentioned media publications in a simple and easy manner. The solution also incorporates an automated communications-enabled method of obtaining new versions of the software and specific content as needed. This unique integrated content management system may function as part of the product and services delivered. It is the backbone of the automated content delivery system in place for the eReader product.

The system ensures that necessary software updates and media publication content are delivered to end users as required. Media publications may be published on a daily, weekly, bi-weekly, monthly and bimonthly cycle, for example, and are extensive in volume. Books are published at random. The aforementioned delivery system described accomplishes the dissemination of these media publications.

The eReader can easily replace many pounds of paper on the 12 ounce device. Weight savings and easy access to information are clear advantages. Currently, many pounds of media publications are placed on board the aircraft before departure for the passengers' enjoyment.

Cabin Passenger Concept:
The operational concept of the eReader product is that each eReader may be distributed to passengers desirous of its use and seated in business or first class sections of an aircraft. Its use is for the duration of a flight and must be returned upon its end. Passengers seated in coach or economy sections may rent the device for the duration of a flight however the eReader may also be available for purchase as a means for the airlines to produce additional revenue and reduce costs.
The device and/or media publication content may be automatically updated as appropriate. Updates may be manually initiated by the device owner using wireless IP type of communications.
Newly published media publications can be uploaded to each device immediately before a flight departs.
New features can be added to the device via the content management system as they become available and will reduce training requirements due to the commonality of the user interface.

### POS Functionality

Besides reducing onboard paper, there is a significant trend in the airline and railway industries to provide for acceptance of credit cards for payment for a number of services and products offered to customers during travel. The eReader, as a processing platform, allows the integration of a magnetic card strip reader into the device as an optional component. This integration and custom tailored application used to process credit card data, and ultimately to use the eReader communications networks to purchase products and/or validate credit card information, is a compelling, additional benefit to implementing an eReader based system.

When coupled with the eReader communications infrastructure, such as GateLink or SATCOM, reductions in credit card losses can be realized as well as easy implementation of automated inventory control systems. The key to successful implementation includes the criteria of a low possibility of mistakes and reliability. These issues are mitigated by a consistent user interface and a sound technical architecture.

The modular architecture lends itself to adding new functionality without being overly disruptive. New software and media publications can be installed and distributed using a tailored content management server system.

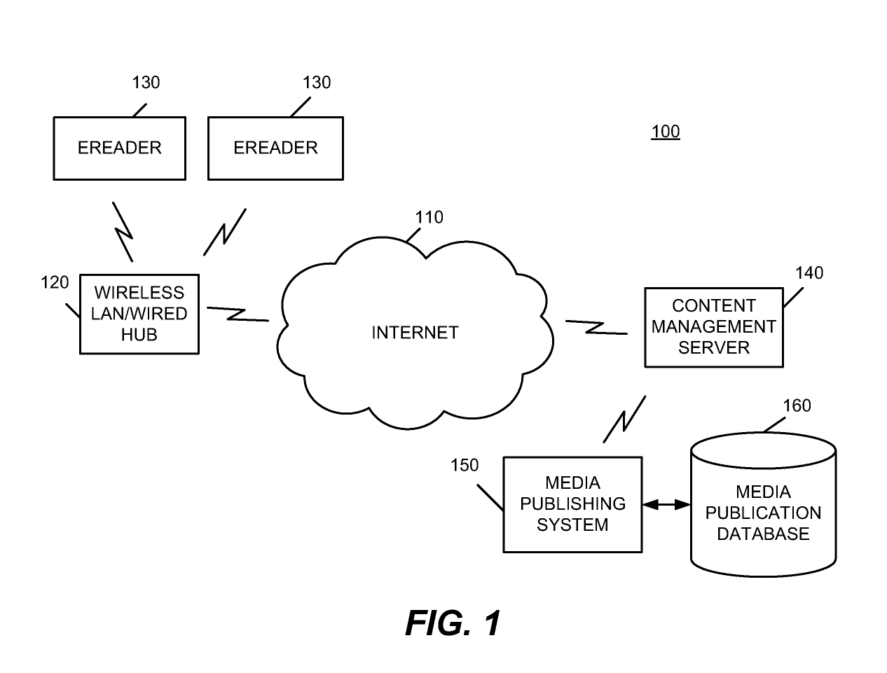

FIG. 1 illustrates an exemplary eReader network system 100 diagram in accordance with a possible embodiment of the disclosure.

eReader system 100 may include wired local area network (LAN)/wired hub 120 and content management server 140 connected to the Internet 110. Wireless land/wired hub 120 may be connected to eReaders 130 and content management server 140 may be connected to one or more media publishing system 150 which is then connected to media publication database 160. Although the connections in FIG. 1 are shown as wireless configuration, one or more of these connections may be wired.

Wireless land/wired hub 120 may represent any land, hub, router, switch, server, computer, or any other device that may serve as an intermediate communication routing device between the Internet 110 and eReaders 130. Content management server 140 may be any server, computer or other similar device capable of storing and managing media publications and other documents and products. The one or more media publishing system 150 may serve as the media publication source for commercial and private media publishers, including books, magazines, newspapers, etc. Media publication database 160 may serve to store up-to-date media publications, including books, magazines, newspapers, etc.

For example, the content features of an eReader 130 for use in by passengers may include the following.

1. Newspapers

2. Magazines

3. Books

4. Shopping (e.g., catalogs, etc.)

5. Games

6. Food and drink menus

7. Flight entertainment list

The eReader 130 may feature two-way communications via an integrated WiFi transceiver as well as via a wired internet connection thru the associated power, USB and internet adapter. This may be utilized by airline/railway passengers, crew or ground personnel, for example. The eReader 130 can be considered to create an IP based secure internet connection back to an appropriately configured content management server 140, either hosted or one integrated into the eReader network 100 or an airline/railway customer's own Intranet.

The airline/railway customer can publish new content for a specific device, group of devices or all devices in their system to receive the new content the next time that airline/railway personnel initiates a connection over the Internet 110. The content management server 140 may also allow the customer to generate status reports describing available device statistics such as successful updates including durations and time parameters.

The user interface for content management on the eReader 130 may provide simplicity, ease of use, and also protect against inadvertent activation or deletion. A simple exemplary four-step procedure may be used that provides adequate warnings, prompts and immediate feedback to the user during all steps of the process. The sequence may be aborted by the airline/railway personnel at any time by pressing a connect/disconnect button and confirming a desire to end the current session.

Once a session begins, the crew or airline/railway personnel may be provided with an indication about what new content is available and have the opportunity to select the data he wishes to receive or send during the session. This capability allows the crew to manually and consciously determine if the time they have available for the session is adequate to transfer data at the moment. For example, if the crew has only a 20 minute window before the flight, train, etc. must depart, the crew may note that one of the specific media publication's size requires a 22 minute connection, he may choose to download the data at another time when there is a longer window of opportunity. These types of features may be configurable by the system manager and may be configured so as not to allow this specific choice.

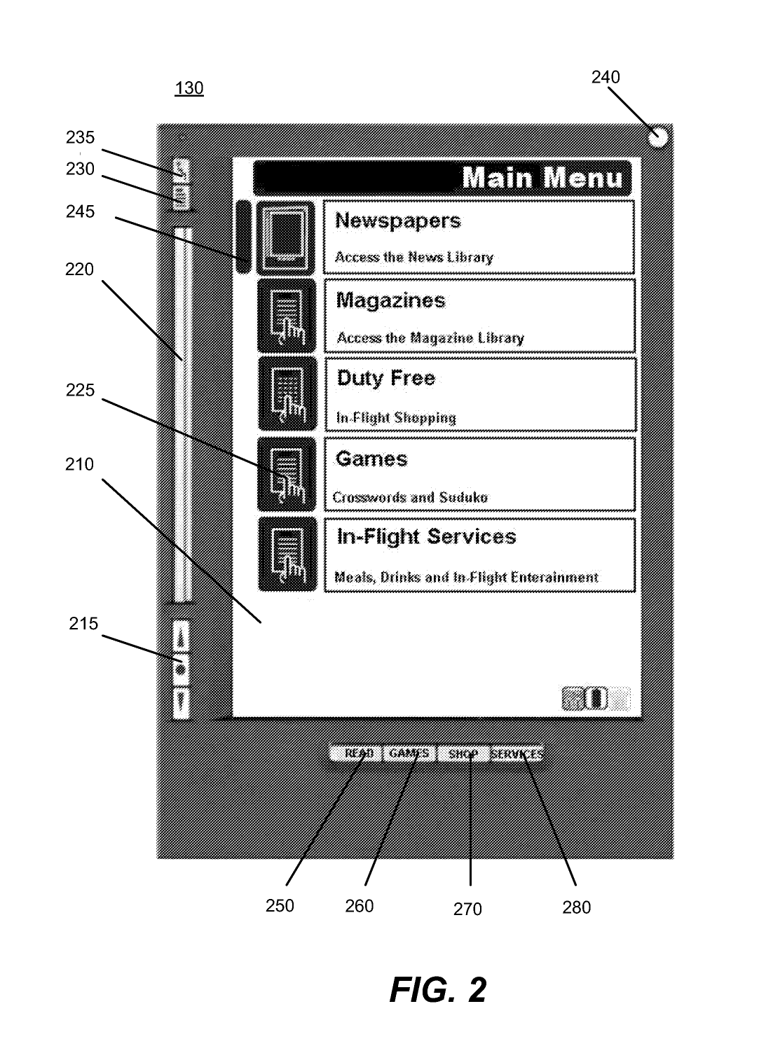

FIG. 2 illustrates an exemplary eReader 130 in accordance with a possible embodiment of the disclosure. eReader 130 may include several user interface buttons and screens to facilitate the user's interaction with the device and its content. For example, the eReader 130 may include a display screen 210 that presents information, menus, and selections 225 to the user, scroll and select buttons 215, page left/right bar 220, main menu button 230, back button 235, cursor 245, WiFi connect 240, and a plurality of main function buttons, including read button 250, games button 260, shop button 270, and services button 280. A user may make selections using the hard button or soft buttons by using a stylus on the display screen 210, for example. Please note that the buttons and screen displays shown are merely exemplary, and can be modified to meet the needs of aircraft and crew in accordance with methods known to one of skill in the art.

The display screen 210 may be an eletrophoretic (ePaper) display that possesses a paper-like high-contrast appearance, ultra low power consumption, and a thin, light form. The ePaper display 210 gives the viewer the experience of reading from paper while having the ability to receive electronic updates. The ePaper display 210 is enabled by “electronic ink” which is essentially pigments that carry a charge enabling a display to be updated through electronics in order to produce an image. Electronic ink is ideally suited for ePaper as it is a reflective technology which requires no front or back light and is viewable under a wide range of lighting conditions, including direct sunlight, and requires no power to maintain an image.

The eReader 130 features two-way communications via an integrated WiFi transceiver 240 as well as a wired Internet connection through the associated power, USB, and internet adapter (not shown). The device can be considered to create an IP based secure Internet connection back to an appropriately configured content management server 140, either hosted or one integrated into a communications network or a customer's own Intranet. Customer airlines or railways may also publish new content for a specific eReader 130, group of eReaders 130, or all eReaders 130 in their system to receive the new content the next time they initiate a connection over the Internet.

When a user selects a specific function (by hard or soft button activation), the display screen 210 is replaced with a screen that details the available documents or functions at a next level down in the hierarchy. Thus, eReader 130 may have nested functionality until ultimately the desired document is opened and displayed.

The user interface may be page oriented and not windowed. For applications such as the games, returning to that function by pressing the games button 260 for instance, may re-display the games application from where it was left. Thus, there may be no need to re-navigate back to the specific pages on which the user was working.

The same may apply to media publications. Once a publication is opened and a specific page is viewed, the next time the publication is opened, the same page may be displayed. There may also be a feature that allows immediate navigation to the table of contents as well.

With respect to the read button 250, the eReader 130 may display a menu of stored publications, such as books, magazines, newspapers, etc. in a manner known to one of skill in the art. In this manner, a passenger may select a desired publication for viewing and reading.

Also note that if more than 1 page of messages is available on the eReader 130, there may be an indication at the bottom of the screen indicating how many pages of messages are available (i.e., 1 of 3). Note: there is a cursor-like indicator (vertical bar) that is always moved to indicate the selected function etc. In this case, until another message is selected, the bar indicates which message was last read.

With respect to the games button 260, the eReader 130 may display a menu of stored games, such as video games, games from known game systems, puzzles, etc. There may also be a slot provided in the eReader 130 to insert commercial game cartridges. In addition, an ability to provide interactive gaming ability may be provided so that an individual may play against another passenger.

With respect to the shop button 270, the eReader 130 may display items and catalogs from which the user may purchase items for sale. As discussed herein, the eReader 130 may be linked with a point-of sale (POS) transaction system. In this manner, the passenger may be able to select one or more items for purchase and then have that information downloaded to a device to handle the purchase transaction. The eReader 130 may be outfitted with a credit card reader to facilitate purchases. This credit card slot may also be used for activation of the eReader 130 in a “pay-as-you-go” system whereby the passenger would have to pay for use of the eReader 130 or for viewing certain publications, games, etc.

There may also be many more document viewer specific functions, like zoom, pan, and annotation commands. A very important topic for in-depth discussion is that of document formatting, architecture, and publishing strategies. Due to the actual size of the eReader 130 display area, it is important to design documents to incorporate attributes, such as page size, font, and imbedded hyperlinks, to be usable on the eReader 130.

Another important factor is to consider publishing documents in small pieces, perhaps as chapters or sections in order to exploit the eReader 130 type of content management capabilities that can transmit reduced size sections, or only the changed portions of documents instead of sending an entire document. This method may result in cost and time savings.

The services button 280 may provide the passenger with a list on travel services provided by the airline or railway.

The eReader 130 provides the capability to allow users to use a stylus to manually write on the device, just like paper. The eReader 130 supports manually written text to be drawn over images and forms stored on the device. The stylus may be used with all functions of the eReader 130, including reading, games, shop, services, etc.

Organized in folders, eReader 130 may provide access to any number of templates in the form of images (tiff, jpg, gif and bmp files, etc.) as well as PDF files. The handwriting may be saved and associated to the corresponding template and can be modified again, deleted, or even marked for upload back to other systems using the eReader 130.

There may also be a rich set of drawing functionality available such as selecting pen size and ink styles. Example of templates already developed include flight plan forms, meteorological information note pads, compliance certificates, and even blank lined paper for free form note taking. All user entered drawings may be stored associated to their originating template as well as time and date that they were saved.

There is much more low level functionality available like selecting pen size for marking notes, but is not documented in this disclosure

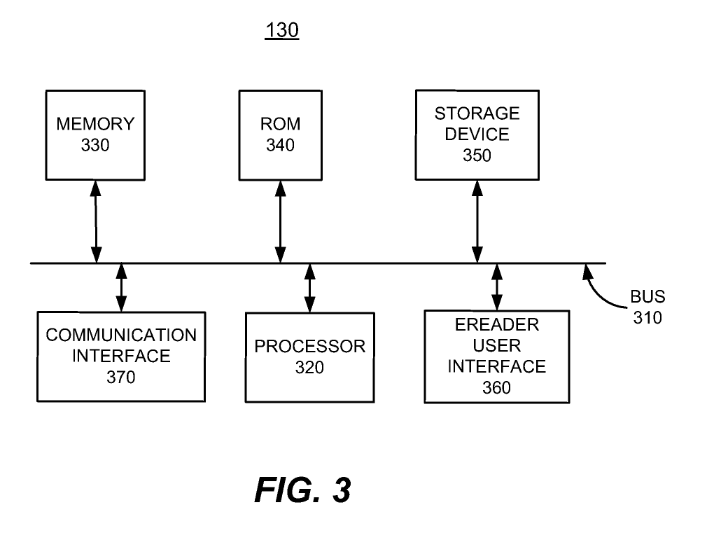

FIG. 3 illustrates a block diagram of an exemplary eReader 130 in accordance with a possible embodiment of the disclosure. The eReader 130 may include a bus 310, a processor 320, a memory 330, a read only memory (ROM 340, a storage device 350, an eReader user interface 360, and a communication interface 370. The bus 310 may permit communication among the components of the eReader 130.

The processor 320 may include at least one conventional processor or microprocessor that interprets and executes instructions. Memory 330 may be a random access memory (RAM or another type of dynamic storage device that stores information and instructions for execution by processor 320. Memory 330 may also include a read-only memory (ROM which may include a conventional ROM device or another type of static storage device that stores static information and instructions for processor 320.

The communication interface 370 may include any mechanism that facilitates communication via the network 110. For example, the communication interface 370 may include a modem. Alternatively, the communication interface 370 may include other mechanisms for assisting in communications with other devices and/or systems.

ROM 340 may include a conventional ROM device or another type of static storage device that stores static information and instructions for the processor 320. The storage device 350 may include any type of storage media, such as, for example, magnetic or optical recording media and its corresponding drive.

The eReader user interface 360 may include one or more conventional input mechanisms that permit a user to input information, communicate with the eReader 130, and/or present information to the user, such as an electronic display, microphone, touchpad, keypad, keyboard, mouse, pen, stylus, voice recognition device, buttons, one or more speakers, etc. Output mechanisms for the eReader user interface 360 may include one or more conventional mechanisms that output information to the user, including a display, a printer, one or more speakers, or a medium, such as a memory, or a magnetic or optical disk and a corresponding disk drive.

The eReader 130 may perform such functions in response to the processor 320 by executing sequences of instructions contained in a computer-readable medium, such as, for example, memory 330. Such instructions may be read into memory 330 from another computer-readable medium, such as a storage device or from a separate device via the communication interface 370.

The eReader 130 illustrated in FIGS. 1 and 2 and the related discussion are intended to provide a brief, general description of a suitable communication and processing environment in which the disclosure may be implemented. Although not required, the disclosure will be described, at least in part, in the general context of computer-executable instructions, such as program modules, being executed by the eReader 130, such as a communication server, communications switch, communications router, or general purpose computer, for example. Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

For illustrative purposes, the operation of the eReader 130 will be described below in relation to the diagrams shown in FIGS. 1-3.

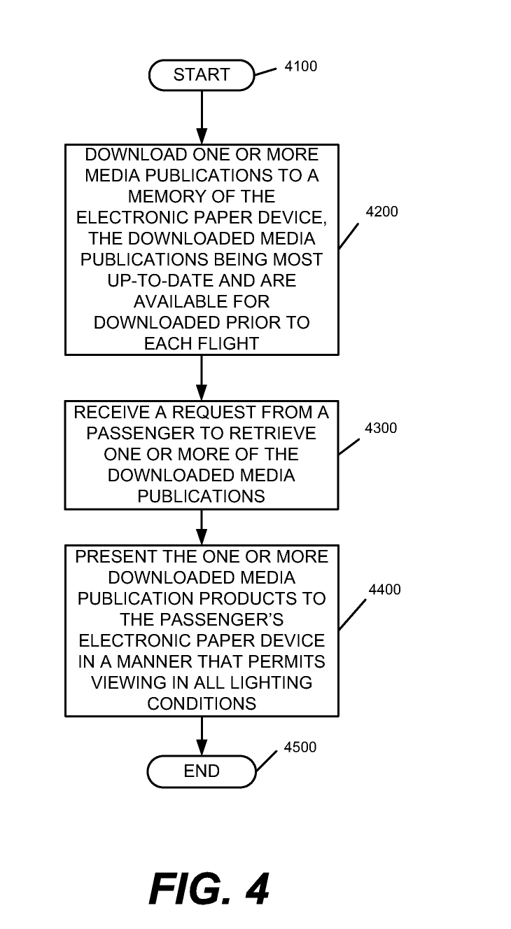

FIG. 4 is an exemplary flowchart illustrating one possible eReader 130 implementation process in accordance with one possible embodiment of the disclosure. The process begins at step 4100 and continues to step 4200 where the eReader 130 downloads one or more requested media publications to the eReader memory 330. The downloaded media publications are advantageous because they are the most up-to-date media publications commercially available and delivered to the eReader 130 just prior to flight. At step 4300, the eReader receives a request from a passenger to retrieve one or more of the downloaded media publications. At step 4400, the eReader 130 presents the one or more downloaded media publications to the passenger so that the passenger may be able to view it in lighting conditions similar to that required by paper, including direct sunlight. In this manner the passengers can view the documents in an enjoyable and efficient manner. The process then goes to step 4500 and ends.

Note that the eReader 130 may also receive input from a passenger and transmit that input to another device, server, etc., such as the content management server 140. For example, a passenger may use the stylus to mark up a form, write an electronic message, etc. and the eReader 130 would then transmit the document to the appropriate device/server.

### SUMMARY

In summary, the eReader 130 conveniently and easily provides airline/railway passengers with a robust set of capabilities targeted at reducing paper dependencies and streamlining acquisition of the information that they require to ensure an enjoyable travel experience.
The basic media publication viewing functionality provided can also be augmented by integrating other entertainment applications, such as games.
Airline operations may become more efficient as all the desired components can be implemented to take advantage of the automated content management system to deliver media publications and other information.
The modular nature of the system architecture allows for new applications to be implemented as needed or desired. The folder structure/metaphor used in organizing and navigation can be expanded upon to add for functionality as new folders or items within, for instance, an application folder.
The internal memory capacity and various media support provided by the eReader ensures that there is plenty of mass storage available for new data, information and applications.
The eReader product is robust and provides a comprehensive portfolio of capabilities and many other uses/features may be integrated in the future.
The scalability and configurability of the system is a feature that allows the system to be tailored for different customers to accommodate their unique requirements easily.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosure, rather than any specific examples given.

What is claimed is:

1. An electronic paper device for use by passengers, comprising:
a communication interface that facilitates downloading of media publications, the media publications being and available for download prior to each flight;
a memory that stores the media publications;
a user interface that facilitates access and use of the media publications by a user; and
an electronic paper display that displays the media publications to the user in a manner that permits viewing in all lighting conditions similar to that required by paper, including bright sunlight.

2. The electronic paper device of claim 1, wherein the user interface includes a plurality of buttons which allow direct access to at least one of media publications, magazines, newspapers, shopping, games, food and drink menus, entertainment, and notes.

3. The electronic paper device of claim 1, further comprising:
a stylus for use with the electronic paper display, wherein marks on the electronic paper display made using the stylus are recorded and converted to one of electronic text and electronic drawings.

4. The electronic paper device of claim 3, wherein the electronic text and the electronic drawings are stored in the memory.

5. The electronic paper device of claim 1, further comprising:
a Wi-Fi transceiver coupled to the communication interface that facilitates downloading of media publications and transfer of data generated by the user of the electronic paper device.

6. The electronic paper device of claim 1, wherein the media publications are downloaded from a content management server, the content management server maintaining a repository of most-current media publications.

7. The electronic paper device of claim 1, wherein the user interface provides access to point-of-sale tools, the point-of-sale tools enabling passengers to record and transmit point-of-sale transactions.

8. The electronic paper device of claim 1, further comprising:
a pop-up keyboard that facilitates the entering of information to the electronic paper device.

9. The electronic paper device of claim 1, wherein the media publications may include at least one of magazines and newspapers.

10. A method of providing aviation-related documents to passengers using an electronic paper device having an electronic paper display, comprising:
downloading one or more media publications to a memory of the electronic paper device, wherein the downloaded media publications are up-to-date and available for download prior to each flight;
receiving a request from a user to retrieve one or more of the downloaded media publications; and
presenting the one or more downloaded media publications to a user of the electronic paper device in a manner that permits viewing in all lighting conditions similar to that required by paper, including bright sunlight.

11. The method of claim 10, further comprising:
receiving input from the user via a user interface, the user interface including a plurality of buttons which allow direct access to at least one of media publications, magazines, newspapers, shopping, games, food and drink menus, entertainment, and notes.

12. The method of claim 10, further comprising:
receiving input from the user via a stylus for use with the electronic paper display, wherein marks on the electronic paper display made using the stylus are recorded and converted to one of electronic text and electronic drawings.

13. The method of claim 12, wherein the electronic text and the electronic drawings are stored in the memory.

14. The method of claim 10, wherein the media publications are downloaded using a Wi-Fi transceiver coupled to the communication interface, the Wi-Fi transceiver facilitating transfer of data generated by the user of the electronic paper device.

15. The method of claim 10, wherein the media publications are downloaded from a content management server, the content management server maintaining a repository of most-current media publications.

16. The method of claim 10, further comprising:
receiving point-of-sale transaction information; and
transmitting point-of-sale transaction information to devices that facilitate processing of the transaction for payment.

17. The method of claim 10, further comprising:
receiving input from the user via a pop-up keyboard that facilitates the entering of information to the electronic paper device.

18. The method of claim 10, wherein the media publications may include at least one of magazines and newspapers.

19. A user interface for an electronic paper device for use by passengers, comprising:
an electronic paper display that displays media publications to the user in a manner that permits viewing in all lighting conditions; and
a plurality of buttons which allow direct access to at least one of media publications, magazines, newspapers, shopping, games, food and drink menus, entertainment, and notes.

20. The user interface of claim 19, wherein the media publications may include at least one of magazines and newspapers.
